(19) United States
(12) Patent Application Publication
(10) Pub. No.: US 2013/0057001 A1
(43) Pub. Date: Mar. 7, 2013

(54) Gripping Device with Claw and Electrical-Operated Magnetic Disk

(71) Applicant: CHING-HUI TSAI, New Taipei City (TW)

(72) Inventor: CHING-HUI TSAI, New Taipei City (TW)

(21) Appl. No.: 13/292,084

(22) Filed: Nov. 9, 2011

(30) Foreign Application Priority Data
Sep. 1, 2011 (TW) 100216364

(51) Int. Cl. B66C 1/00; B66C 1/42; B66C 1/06

(52) U.S. Cl. 294/24

(57) ABSTRACT

A gripping device comprises a base, claws, cylinders, and an electrical-operated magnetic disk. At least two claws are pivotally coupled to the base. The base is provided with a coupling portion, which can be pivotally coupled to an arm of an operation machine. Each claw is pivotally coupled to a first location of a vertical plate of the base. Each cylinder is pivotally coupled to one of the claws. When the claws hold together, an accommodating space can be defined, in which the disk is mounted. The disk is provided with a central shaft, which can be fitted in a central space of the base. Thereby, large pieces of metal can be gripped by the claws, whereas small pieces of iron can be picked up by the electrical-operated magnetic disk, so that one machine employing the gripping device can take large pieces of metal and small pieces of iron.

### (a) TECHNICAL FIELD OF THE INVENTION

The present invention relates to a gripping device and, more particularly, to a gripping device that includes claws and an electrical-operated magnetic disk, and occupies less space in the operation site, whereby, when handling waste resources, large pieces of metal can be gripped by the claws, whereas small pieces of iron can be picked up by the electrical-operated magnetic disk being electrically energized, so that a machine employing the gripping device can reduce the time required for the recycling operation and the cost of the equipments required in the operation site can be reduced, so that the competitiveness of the business can be increased.

### (b) DESCRIPTION OF THE PRIOR ART

Regarding the steps of recovering waste resource, various wastes are first picked up by individuals and transported to a small collection site, in which the metal resources can be classified into different groups of metal, such as copper, iron, or the like. Thereafter, the classified metals can be transported to a large collection site, through which the classified metals can be transported in large bulk to exporters or various metal-melting plants, so that the metals can be re-used.

Since the metal can be a leftover from a metal processing plant, or a large piece of metal from a large home appliance or machine that is discarded, a collection site should have appropriate equipments for handling or lifting the metal pieces, among which the basic equipments include a gripping device, which can be coupled to an arm of a lifting machine or a crane, and an electrical-operated magnetic disk, which is mounted on a different machine and can be electrically energized to generate magnetic force for picking up small iron metal. However, the space within a resource collection site is limited, two machines would occupy too much space, causing a less space left for operation. Also, in the operation, large pieces of metal should be first gripped by the lifting machine and loaded onto a transport vehicle, and then small pieces of iron metal may be picked up by the machine equipped with the magnetic disk, and loaded onto the transport vehicle. This type of operation requiring two different machines is commonly seen in the recycling industry, which is time and space consuming.

It is obvious that the resource collection sites lack an operation machine that can handle large and small pieces of metals by itself, to reduce the time and the space required for the operation. Because the existing operation machines for handling the recycling resources would consume more time, land, and money, the way of managing the business is not economical. There is a need for further improvement.

In view of those defects in the existing operation machines for recycling resources, the applicant has developed a device, including claws and an electrical-operated magnetic disk, that can be employed to an operation machine, through which the recycling operation can be proceeded more conveniently and quickly, and the space required for the operation machine can be reduced, so that the competitiveness of the business can be increased.

### SUMMARY OF THE INVENTION

The primary object of the present invention is to provide a gripping device, including claws and an electrical-operated magnetic disk, wherein the base thereof is coupled with the claws at a periphery thereof, and is mounted with the electrical-operated magnetic disk therein. Also, a plurality of hydraulic cylinders are employed in the present invention. Thereby, when handling waste resources, large pieces of metal can be gripped by the claws, whereas small pieces of iron can be picked up by the electrical-operated magnetic disk being electrically energized, so that one machine employing the gripping device can take large pieces of metal and small pieces of iron.

Another object of the present invention is to provide a gripping device that is further provided a swivel seat at the base thereof, so that a related machine can change the angle of the gripping device to facilitate an operation.

To achieve the above objects, the gripping device of the present invention may include a base, a plurality of claws, a plurality of cylinders, and an electrical-operated magnetic disk, the improvement comprising: the base being provided with a coupling portion at a top thereof, the claws being coupled to a periphery of the base, a central space being defined at a center of the base for mounting with the electrical-operated magnetic disk; the claws each having a curved shape so that, when the claws hold together, an accommodating space can be defined, each claw being pivotally coupled to the periphery of the base; one end of each of the cylinders being pivotally coupled to a second pivot hole of one of the claws, the other end of each of the cylinders being pivotally coupled to a pivot hole at a second location of a vertical plate; and the electrical-operated magnetic disk being mounted in the accommodating space defined by the claws when they hold together, the electrical-operated magnetic disk being provided with a central shaft at a rear thereof, the central shaft being fitted in the central space of the base; whereby, when handling waste resources, large pieces of metal can be gripped by the claws, whereas small pieces of iron can be picked up by the electrical-operated magnetic disk, so that one machine employing the gripping device can take large pieces of metal and small pieces of iron.

Other objects, advantages, and novel features of the present invention will become more apparent from the following detailed description when taken in conjunction with the accompanying drawings.

### BRIEF DESCRIPTION OF THE DRAWINGS

FIG. 1 is an exploded view of the present invention.

FIG. 2 is a 3-dimensional view of the present invention.

FIG. 3 is a side view of the present invention, in which the claws thereof are in a held state.

FIG. 4 is a side view of the present invention, in which the claws thereof are in an unfolded state.

FIG. 5 is a schematic view of the present invention, in which the claws thereof are in an unfolded state and the electrical-operated magnetic disk thereof is electrically energized to generate a magnetic force.

FIG. 6 is a side view of the present invention, in which the electrical-operated magnetic disk thereof is moved outward by a variable shaft provided from a hydraulic cylinder.

FIG. 7 is a side view of the present invention, which is further provided with a swivel seat at a rear end of the base thereof, so that the angle of the present invention can be changed to facilitate an operation.

### DETAILED DESCRIPTION OF THE PREFERRED EMBODIMENTS

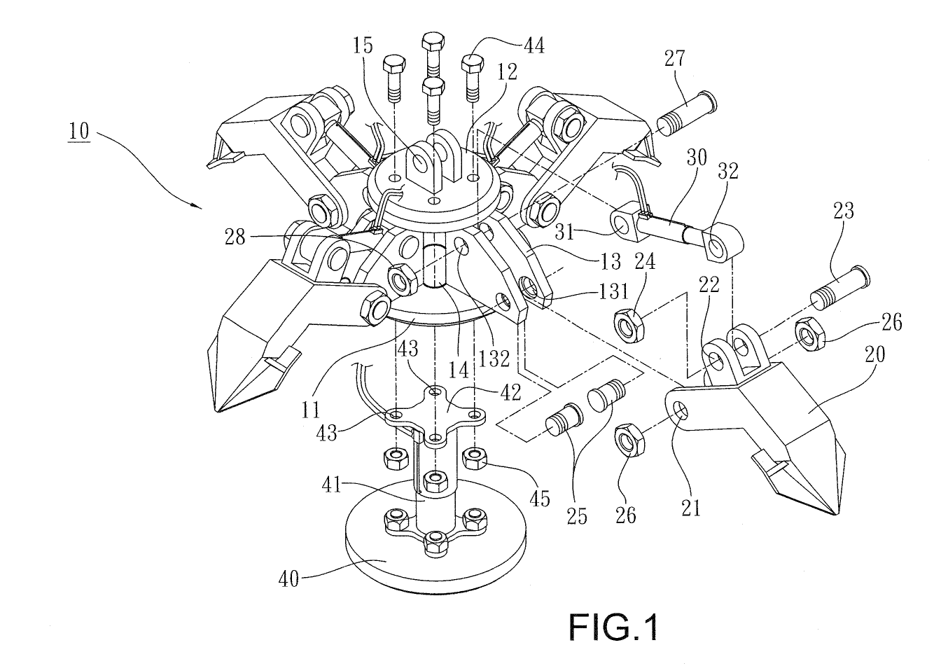

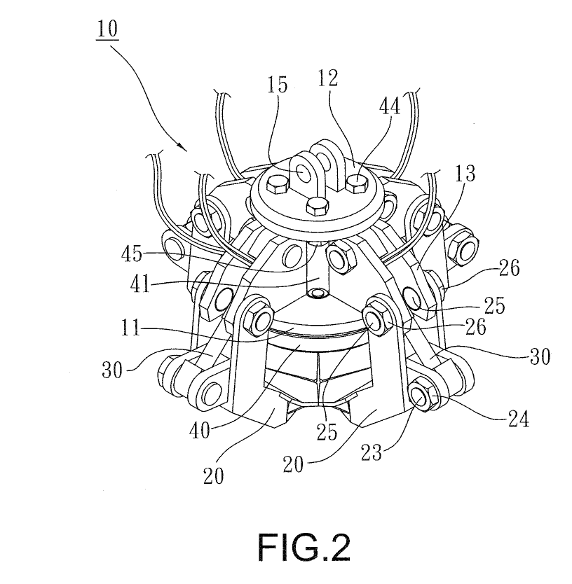

Turning now to FIGS. 1-3, one embodiment of a gripping device 10, with claw and electrical-operated magnetic disk, according to the present invention is illustrated. The gripping device 10 generally comprises a base 11, a plurality of claws 20, a plurality of cylinders 30, which can be hydraulic cylinders, and an electrical-operated magnetic disk 40.

The base 11 is provided with a coupling portion 12 at a top thereof, the coupling portion 12 defining a pivot hole 15. The base 11 is provided with a plurality of vertical plates 13 at a periphery thereof. Preferably, the base 11, the coupling portion 12, and the vertical plates 13 are welded together to form an integral member. Alternatively, those parts can be integrally formed by sand casting. Each of the vertical plates 13 defines a stepped hole 131 at a first location thereof and a pivot hole 132 at a second location thereof. As shown, although the vertical plates 13 are arranged in pairs to cooperate with one of the claws 20, the vertical plates 13 can be arranged in a single piece to cooperate with a corresponding claw. A central space 14 is defined at a center of the base 11 for mounting with the electrical-operated magnetic disk 40.

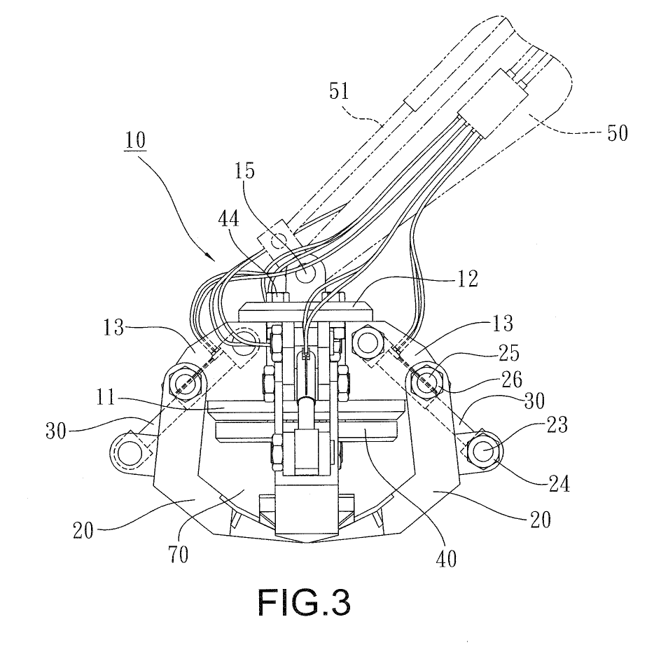

Each of the claws 20 has a curved shape so that, when the claws 20 hold together, an accommodating space 70 (see FIG. 3) can be defined. Each of the claws 20 defines a first pivot hole 21 at a first location thereof and a second pivot hole 22 at a second location thereof.

In assembling, each of the claws 20 can be placed over one pair of the vertical plates 13, wherein a bolt 25 can insert through the stepped hole 131 of a corresponding vertical plate 13 and the first pivot hole 21 of the corresponding claw 20, and then a nut 26 can be threadedly engaged with the bolt 25. The cylinder 30 can be coupled to one of the claws 20 by using a bolt 23 inserted through the second pivot hole 22 of the corresponding claw 20 and a pivot hole 32 of the cylinder 30 at one end thereof to engage with a nut 24. Also, the cylinder 20 can be coupled to the corresponding vertical plate 13 by using a bolt 27 inserted through the pivot hole 132 of the corresponding vertical plates 13 and a pivot hole 31 of the cylinder 30 at the other end thereof. With such assembly, when the cylinder 30 is driven by a hydraulic pump to extend or retract, the claws 20 can be driven to hold together or unfold.

The electrical-operated magnetic disk 40 is mounted in the accommodating space 70 (see FIG. 3) defined by the claws 20 when they hold together. The electrical-operated magnetic disk 40 is provided with a central shaft 41 at a rear thereof. A preferable way of combining the central shaft 41 with the base 11 is using bolts and nuts. As shown, the central shaft 41 is provided with a fastening plate 42, which defines a plurality of holes 43 along a periphery thereof, wherein the central shaft 41 is fitted in the central space 14 of the base 11, and bolts 44 are inserted through holes of the coupling portion 12 and the holes 43 of the fastening plate 42 to engage with nuts 45, so that the electrical-operated magnetic disk 40 can be mounted in the accommodating space 70 defined by the claws 20 holding together. The central shaft 41 provided at the rear of the electrical-operated magnetic disk 40 can be a fixed-length shaft, or a variable-length shaft, which can be provided from a hydraulic cylinder. When the central shaft 41 is provided from a hydraulic cylinder, it can be extended outward, before the electrical-operated magnetic disk 40 is electrically energized to generate magnetic force for picking up iron metal, to facilitate an operation.

The base 11 can be pivotally connected to an arm 50 of an operation machine and a cylinder 51 (see FIG. 3) through the pivot hole 15 of the coupling portion 12, so that the gripping device can be moved by the operation machine to a different location of the collection site for operation. With the gripping device, when handling waste resources, large pieces of metal can be gripped by the claws 20, whereas small pieces of iron, which cannot be gripped by the claws, can be picked up by the electrical-operated magnetic disk 40 being electrically energized to generate magnetic force, so that one machine employing the gripping device can take large pieces of metal and small pieces of iron in itself.

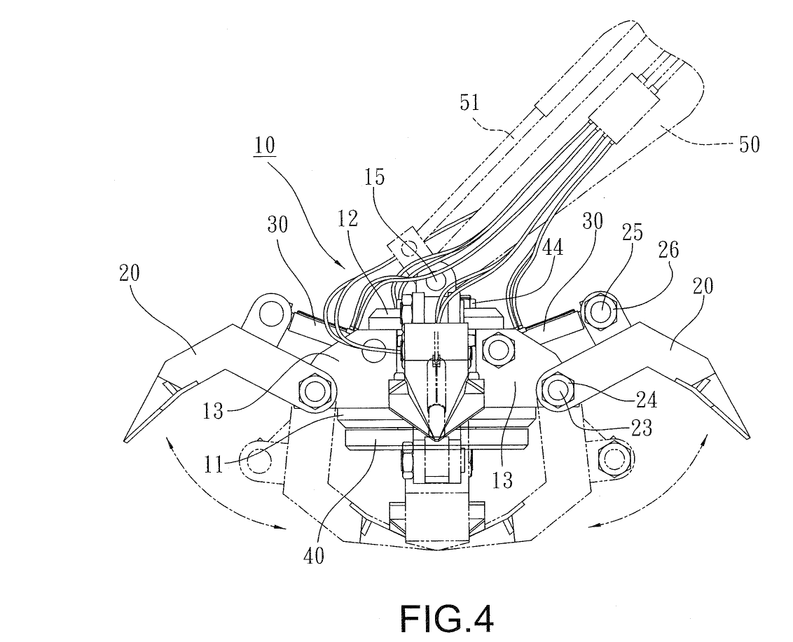

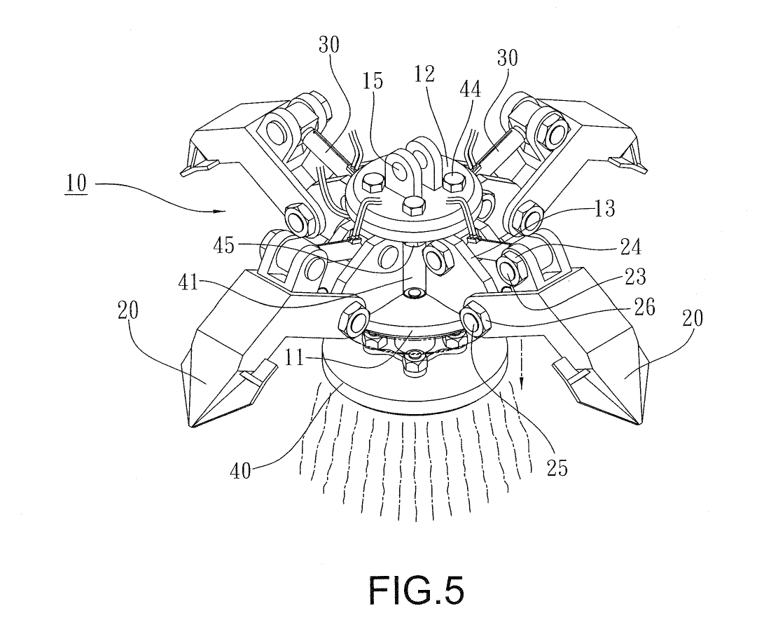

In operation, as shown in FIGS. 4 and 5, the cylinder 30 can be actuated by an operation machine to have the claws 20 to hold together or unfold for gripping large pieces of metal. After the large pieces of metal have been moved, small pieces of iron, which cannot be gripped by the claws 20, can be picked up, by the electrical-operated magnetic disk 40 being electrically energized to generate magnetic force, and loaded onto a transport vehicle.

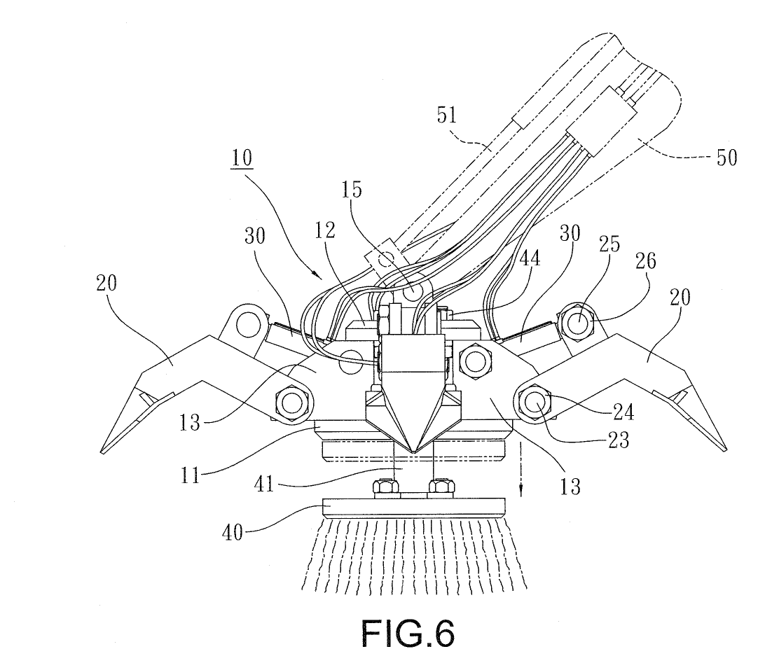

Turning next to FIG. 6, as mentioned above, the central shaft 41 at the rear of the electrical-operated magnetic disk 40, may be a shaft provided from a hydraulic cylinder. Thus, when the claws 20 is in an unfolded state, the variable shaft may extend outward, before the disk 40 being electrically energized to generate magnetic force, to facilitate the operation of collecting iron metal.

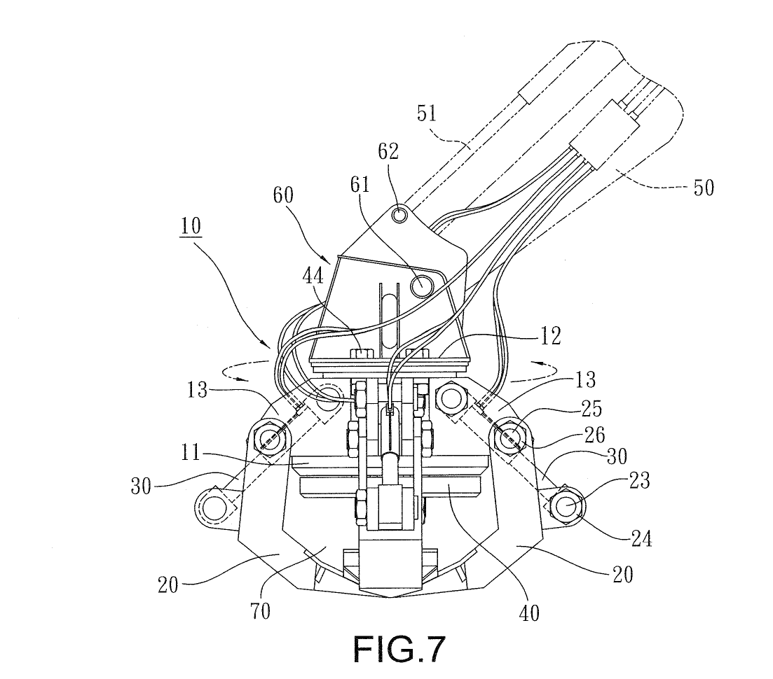

Turning next to FIG. 7, the gripping device may be further provided with a swivel seat 60 at a rear end of the base 11. The swivel seat 60 defines a first pivot hole 61, for being pivotally coupled to an arm 50 of an operation machine, and a second pivot hole 62, for being pivotally coupled to a cylinder 51 on the arm 50. With such element, the operation machine can change the angle of the gripping device to facilitate an operation.

In light of the foregoing, the present invention can provide a design that can achieve the purpose of using one machine to conduct two types of operation, allow the operation of handling recycling metal to be more easily and quickly, and save the space required for operating the machine, so that the competitiveness of the business can be increased. Thus, it is a useful design.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. In a gripping device of the type including a base, a plurality of claws, a plurality of cylinders, and an electrical-operated magnetic disk, wherein the improvement comprises:
said base being provided with a coupling portion at a top thereof, said claws being coupled to a periphery of said base, a central space being defined at a center of said base for mounting with said electrical-operated magnetic disk;
said claws each having a curved shape so that, when said claws hold together, an accommodating space can be defined, each said claw being pivotally coupled to the periphery of said base;
one end of each of said cylinders being pivotally coupled to a second pivot hole of one of said claws, the other end of each of said cylinders being pivotally coupled to a pivot hole at a second location of a vertical plate; and
said electrical-operated magnetic disk being mounted in the accommodating space defined by said claws when they hold together, said electrical-operated magnetic disk being provided with a central shaft at a rear thereof, said central shaft being fitted in said central space of said base;
whereby, when handling waste resources, large pieces of metal can be gripped by said claws, whereas small pieces of iron can be picked up by said electrical-operated magnetic disk, so that one machine employing the gripping device can take large pieces of metal and small pieces of iron.

2. The gripping device of claim 1, wherein said claws are pivotally coupled to the periphery of said base, said vertical plates are provided at the periphery of said base, each said vertical plate defining a stepped hole at a first location thereof and a pivot hole at a second location thereof, each said claw defining a first pivot hole at a first location thereof and a second pivot hole at a second location thereof, said first pivot hole of each said claw being arranged in pivotal cooperation with said stepped hole of one of said vertical plates, between said second pivot hole of each said claw and said pivot hole at the second location of each said vertical plate being pivotally mounted with one of said cylinders, which are hydraulically driven.

3. The gripping device of claim 1, wherein said central shaft is provided with a fastening plate at a rear end thereof, said fastening plate defining holes along a periphery thereof, so that said central shaft can be fitted in said central space of said base, and fastened to said base by using bolts inserted through said coupling portion of said base to engage with nuts.

4. The gripping device of claim 2, wherein said central shaft is provided with a fastening plate at a rear end thereof, said fastening plate defining holes along a periphery thereof, so that said central shaft can be fitted in said central space of said base, and fastened to said base by using bolts inserted through said coupling portion of said base to engage with nuts.

5. The gripping device of claim 1, wherein the number of said claws coupled to said base is more than two.

6. The gripping device of claim 1, said central shaft is a length-variable shaft provided from a hydraulic cylinder.

7. The gripping device of claim 1, wherein said base is provided with a swivel seat at a rear end thereof.
